(19) United States
(12) Patent Application Publication
(10) Pub. No.: US 2005/0071752 A1
(43) Pub. Date: Mar. 31, 2005

(54) Forms management system

(76) Inventor: Jane E. Marlatt, Linfield, PA (US)

Correspondence Address: Alexander J. Burke;Intellectual Property Department, 5th Floor, 170 Wood Avenue South, Iselin, NJ, 08830, US

(21) Appl. No.: 10/949,143

(22) Filed: Sep. 24, 2004

Related U.S. Application Data
(60) Provisional application No. 60/505,586, filed on Sep. 24, 2003.

(51) Int. Cl. G06F 17/21

(52) U.S. Cl. 715/506; 715/505; 715/530

(57) ABSTRACT

A method for providing a user interface enabling a user to determine properties of an electronic form, comprising the activities of: generating data representing a displayable image enabling a user to determine properties of an electronic form, the displayable image including a user selectable button enabling user initiation of an image window supporting, user determination of criteria comprising one or more criterion; and initiating generation of data representing the image window in response to user activation of the selectable button.

### CROSS-REFERENCE TO RELATED APPLICATIONS

This application claims priority to pending provisional application Ser. No. 60/505,586 (Applicant Docket No. 03P14816US), filed 26 Sep. 2003.

### BACKGROUND

Existing forms management systems offer limited functionality for defining and/or modifying forms with a screen builder system. For example, existing systems use a screen builder and decision tables for rendering of forms, and use document builders that fail to support printable form definitions and use a printable form designer system as well. Certain systems use decision tables that reside outside of a form designer and require a separate maintenance step. Existing systems provide limited conditional logic support at the screen level and at the element level; however, they require multiple steps to implement and are not displayed in one place.

Systems according to the principles of the embodiments described herein address the identified deficiencies and associated problems.

### SUMMARY

A method for providing a user interface enabling a user to determine properties of an electronic form, comprising the activities of: generating data representing a displayable image enabling a user to determine properties of an electronic form, the displayable image including a user selectable button enabling user initiation of an image window supporting, user determination of criteria comprising one or more criterion; and initiating generation of data representing the image window in response to user activation of the selectable button.

### DESCRIPTION OF THE DRAWINGS

The invention and its wide variety of embodiments is more readily understood through the following detailed description, with reference to the accompanying drawings in which:

FIG. 1 is a block diagram of a forms management system 1000;

FIG. 2 is a flow diagram of a method of use 2000 of a forms management system;

FIG. 3 is a user interface 3000 for defining applicability wizard;

FIG. 4 is a user interface 4000 for defining criteria;

FIG. 5 is a user interface 5000 for viewing criteria;

FIG. 6 is a user interface 6000 for viewing criteria;

FIG. 7 is a block diagram of a user interaction diagram 7000;

FIG. 8 is a user interface 8000 for associating criteria with a form;

FIG. 9 is a user interface 9000 for listing criterion values;

FIG. 10 is a user interface 10000 for inserting a form into a workflow;

FIG. 11 is a user interface 11000 for a navigation wizard;

FIG. 12 is a user interface 12000 for applying a trigger;

FIG. 13 is a block diagram of a user interaction diagram 13000 for a navigation wizard;

FIG. 14 is a user interface 14000 for selecting a navigation wizard;

FIG. 15 is a user interface 15000 for a navigation wizard;

FIG. 16 is a user interface 16000 for a navigation wizard;

FIG. 17 is a user interface 17000 for selecting a numeric trigger value;

FIG. 18 is a user interface 18000 for selecting a trigger message;

FIG. 19 is a user interface 19000 for selecting a trigger text value;

FIG. 20 is a section 20000 of XML code associated with a navigation wizard;

FIG. 21 is a user interface 21000 for a calculation wizard;

FIG. 22 is a user interface 22000 for modifying a form by a form designer;

FIG. 23 is a user interface 23000 for modifying a form by a form designer;

FIG. 24 is a data structure 24000 associated with a form;

FIG. 25 is a sequence diagram 25000 for creating a form;

FIG. 26 is a data structure 26000 for applicability criteria;

FIG. 27 is a block diagram of an adaptability tool architecture 27000;

FIG. 28 is a process diagram 28000 for the form user who accesses previously created forms; and

FIG. 29 is a block diagram of an information device 29000.

Definitions

When the following terms are used herein, the accompanying definitions apply:

action—at least one behavior that occurs when a condition is found to be true. One example of an action is “enable last DPT shot”. When the condition is true, the element “last DPT shot” is enabled on an associated form and a form user provides a value for that field. The action is made up of an action operator (ENABLE) and a target member (last DPT shot). More than one action is defined for a trigger.

active—currently in use and/or functioning.

activate—to put into service and/or initiate an action.

associated—related to.

button—a defined area within a user interface that is clicked and/or activated to select a command and/or to initiate an action.

clinical information system—a system adapted to collect, store, and/or analyze data associated with healthcare.

condition—a statement that asserts the dependence of at least one categorical proposition on another. A qualification.

completed—finished and/or concluded.

composite—made up of distinct components.

comprising—including but not limited to.

corresponding—accompanying and/or relating to.

criteria—a standard or value on which a judgment or decision is based.

For example, for forms related to a healthcare application, criteria comprise entity, healthcare unit (HCU), patient class, service type, service sub-type, and/or service, etc.

data—distinct pieces of information usually formatted in a special or predetermined way.

delivering—to give forth or produce.

determine—ascertain, obtain, calculate, and/or provide.

display—to render on a viewable screen.

display condition—a condition that controls whether and/or how an element is displayed.

displayable image—a representation adaptable to be rendered.

electronic form—a rendering of an image with elements such as blanks, spaces, and/or boxes, etc., for the insertion of information.

element—a component.

employed—used.

enabling—to make feasible and/or possible.

form—a document and/or rendering with elements such as blanks, spaces, and/or boxes, etc., for the insertion of information.

format—an arrangement and/or parameter of data relating to the printing, display, and/or rendering of that data.

generation—the act or process of producing an image.

healthcare—the prevention, treatment, and management of illness and the preservation of mental and physical well being through the services offered by the medical and allied health professions.

image—an at least two-dimensional representation of an object and/or phenomenon.

information device—any processing device (in software or hardware) capable of processing information, such as any general purpose and/or special purpose computer, such as a personal computer, workstation, server, minicomputer, mainframe, supercomputer, computer terminal, laptop, wearable computer, and/or Personal Digital Assistant (PDA), etc.

initiate—begin.

invisible—hidden and/or not accessible for viewing.

I/O device—any sensory-oriented input and/or output device, such as an audio, visual, and/or haptic device, etc.

logic condition—a proposition on which another proposition depends.

managed—directed and/or controlled.

optional—possible, but not necessary and/or required.

particular—specific.

patient—a human or other type of animal under supervision for health care purposes.

performed—carried out.

predetermined—established in advance.

plurality—the state of being plural and/or more than one.

print—render data via a printer.

processor—any device and/or set of machine-readable instructions adaptable to perform a specific task. A processor comprises any one or combination of hardware, firmware, and/or software adaptable to perform a specific task. A processor acts upon information by manipulating, analyzing, modifying, converting, transmitting the information to an information device, and/or routing the information to an output device.

property—a characteristic and/or trait.

providing—furnishing and/or supplying.

render—(v.) to make perceptible to a human, for example as data, commands, text, graphics, audio, video, animation, and/or hyperlinks, etc., such as via any visual and/or audio means, such as via a display, a monitor, electric paper, an ocular implant, a speaker, a cochlear implant, etc.

rendering—(n.) a collection of human perceptible information.

represent—to be considered as an acceptable equivalent of.

reproduction device—any sensory-oriented output device, such as, for example, a screen, monitor, display, projector, overhead display, copying machine, fax machine, and/or printer, etc.

response—a reaction to an influence and/or impetus.

satisfaction—fulfillment.

select—choose.

selectable—subject to choice.

sequence—a following of one thing after another.

sequential—ordered in time.

suitable—appropriate to a purpose or an occasion.

supporting—providing with necessary resources.

system—a collection of mechanisms, devices, data, and/or instructions, the collection designed to perform one or more specific functions.

tasks—functions to be performed.

trigger—one or more conditions and one or more resulting actions.

user—a person interfacing with an information device.

user interface—any device and/or mechanism for rendering information to a user and/or requesting information from the user.

user interface command processor—a processor adapted to initiate an instruction responsive to a user input.

user interface image generator—a processor adapted to provide data representing a displayable image enabling a user to determine properties of an electronic form.

visible—perceptible to the eye.

window—a defined area of a visual rendering.

worker—one performing labor.

workflow—a flow or progress of activities.

### DETAILED DESCRIPTION

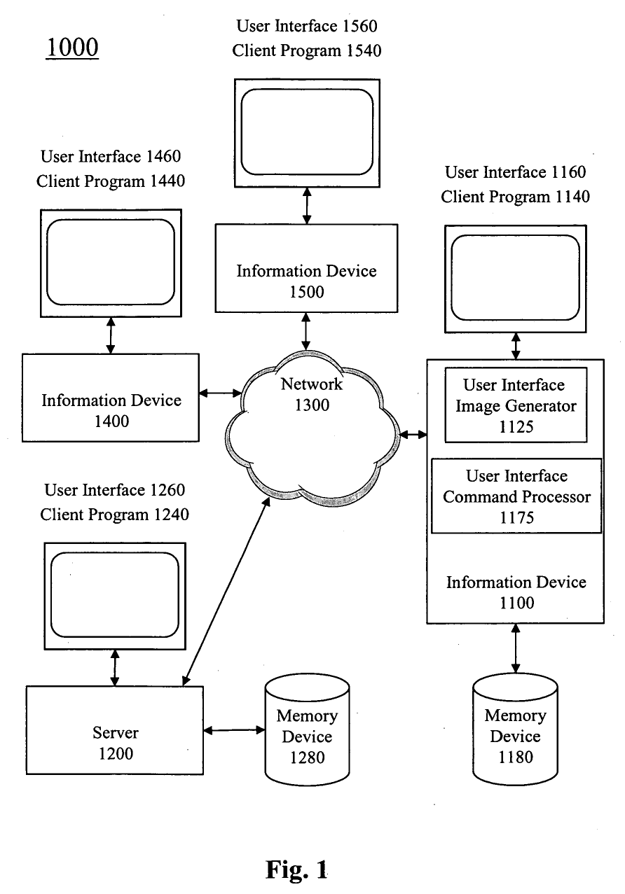

FIG. 1 is a block diagram of a forms management system 1000. Embodiments of forms management system 1000 are geared to serve at least two types of users, namely: a form designer who uses forms management system 1000 to create, modify, and/or test forms, etc.; and a form user who accesses forms directly and/or indirectly via an information device, fills out forms, and/or causes forms to be filled out. The form designer is typically trained in the usage and features of the forms management system.

Forms are paper-based and/or electronic. Applications for forms and/or forms management system 1000 include clinical data collection systems associated with health care; sales control applications associated with vending goods and/or services; investment advising applications associated with securities sales; purchasing applications associated with any business and/or service; information technology applications associated with custom software development; government applications associated with aid programs; government applications associated with information acquisition from governed entities; and/or accounting report applications associated with cost and/or financial functions; etc.

For a form designer, forms management system 1000 comprises an information device 1100, which comprises at least one user interface 1160 and/or a client program 1140. For example, responsive to at least one user selection, client program 1140 creates, modifies, and/or stores a form. User interface 1160 is adapted to receive user input and/or render output to a form designer, such as information related to creating, modifying, and/or storing a form, etc.

Information device 1100 comprises a user interface image generator 1125 and a user interface command processor 1175, which enable the form designer to determine (e.g., input, specify, and/or calculate) and/or view aspects, such as content, input fields, formatting, criteria, properties, etc., of a form. User interface image generator 1125 provides data representing a composite and/or displayable image. Receipt of such data by a display device results in the rendering (e.g., display) of the displayable image, such as a control panel. User interface image generator 1125 enables the form designer, via the control panel, to determine, specify, modify, and/or view aspects of the form. For example, via the control panel, the form designer navigates to an image window where the form designer enters specifications of a particular field of the form, properties of the particular field, conditions describing when the field is displayed on a form, and/or conditions constraining when the form is displayed, if at all, etc.

The control panel includes at least one user selectable button, box, hyperlink, graphic, and/or other user interface element that enables the form designer to initiate and/or open the image window. For example, the displayable image includes a first user selectable button that enables the form designer to initiate and/or open a first image window. Examples of the first user selectable button comprise “OK”, “Accept”, “Enable”, “Display”, “Select”, and/or “Open”, etc. When the form designer selects one of these buttons, a predetermined image window is displayed.

For example, the first image window comprises any number of user-selectable elements related to the creation and/or modification of the form. Elements of the first image window comprise one or more radio buttons, check boxes, buttons, dialog text, pop-up or pull-down menus, required fields, optional fields, fields adapted for manually typed entry, fields restricted by a user selection, and/or fields linking to other openable images adapted to provide information related to at least one user selectable field, etc.

The first image window supports a form designer's determination of when or whether a particular element, such as a field comprised in the form, is displayed on the form and/or at least one property of the element. Determining when or whether the particular element is displayed is accomplished via applying a logic condition. Functions of the at least one property comprise determining whether the particular image element is visible, invisible, active and adapted to initiate a particular action in response to a user selection of the particular image element, inactive, optionally selectable by a form user, and/or completed by the form user, etc. The at least one property is selected responsive to when or whether the particular element is displayed.

The control panel generated by user interface image generator 1125 comprises a second user-selectable button. When the form designer selects the second user-selectable button, a second image window is rendered that allows the form designer to specify, change, and/or determine criteria associated with the form. The criteria comprise one or more criterion, weightable for use in determining when a particular form is to be displayed. For example, for an x-ray procedure, a value indicating a patient sex of female and an age of less than 55 years old causes a form related to patient pregnancy to be displayed. Windows for criterion selection and/or specification are rendered responsive to a user activation of an element, such as a button, selecting a particular window (i.e., displayed image) from one or more sequentially selectable and/or displayable windows. Each particular window is associated with a corresponding task or sequence of tasks.

The form designer creates or modifies controls that determine in what manner (e.g., user interface, print, or processing document) the form appears when the form designer is creating or modifying the form. The form contains data fields that the form user fills and that are related to a specific task. In a healthcare system, for example, the form designer defines criteria; such as processing parameters, service type or subtype, and patient demographic information which may include patient type, patient sex, and/or patient age, etc.; that affect processing parameters or the type of data collected in the form user's workflow for placing an order. In another example, during the ordering of a radiology exam, the form user enters whether a female patient is pregnant so that steps can be taken to protect any fetus from inadvertent exposure to radiation. This data is not needed for male patients. Based on applicability criteria values, the system displays the correct data collection form that contains proper fields.

The forms management system provides an ability to create and/or modify web based data collection forms and print forms. The forms comprise “form definitions” such as conditional logic, applicability criteria, allowable values, defaults, style settings, security task associations, and/or help system-tips, etc. The definitions are creatable and/or changeable within a screen building workflow based upon one or more control panels. Establishing applicability criteria definitions within forms conforms to a one-screen workflow philosophy, which allows for definitions associated with a form to reside within the same workflow. This alleviates adding applicability criteria from within a distinct maintenance step. The navigation wizard user interface displays conditional logic defined for a particular form in a predefined area within the form definition.

The forms management system includes an organizational utility to assist the form designer in maintaining an internal tracking of built forms. In healthcare applications, the forms management system supports the form designer in associating a healthcare unit (HCU) or units with a specific form created for the HCU. This HCU association is part of form definition. The list of HCUs available for association to a form is driven by the values defined in a master file. In addition to HCU associations, the forms management system provides keyword association, this is another mechanism to allow form designers to track which forms have been created for any specific department, diagnosis, and/or specialty, etc. Keyword groups and keywords are user defined (e.g., laboratory, radiology, and/or assessments, etc.). For example, to determine a list of the forms that were created for the lab department for Hospital “A,” the form designer searches to find forms that are associated with criteria of the HCU of Hospital A with a keyword of laboratory. The search returns components associated with requisite criteria.

Criteria are associated with corresponding tasks and/or task sequences. For example, in healthcare applications, a particular criterion such as finding out if a female patient is pregnant prior to performing an x-ray is associated with a task and/or task sequence of performing the x-ray. In healthcare applications associated with patient care, the task sequence comprises tasks managed by a clinical information system. The task sequence comprises tasks performed by at least one healthcare worker in a particular order (i.e., workflow) in delivering healthcare to a patient.

The control panel generated by user interface image generator 1125 includes a user-selectable element associated with printing the form. When a form user selects the image element, the form is formatted in a manner suitable for printing and/or display, such as on a reproduction device and/or monitor.

User interface command processor 1175 initiates rendering the image window responsive to a user selection, such as via activating a button. The user selection is one of a plurality of user selections.

Information device 1100 is communicatively coupled to a memory device 1180. Memory device 1180 stores information related to user created, modified, and/or stored forms acted upon via information device 1100.

Forms management system 1000 comprises a network 1300. Network 1300 is adapted to communicatively couple information devices such as information device 1100 and a server 1200. Architectures for network 1300 comprise a direct connection, local area network, wide area network such as the public switched telephone network, Internet, extranet, or any combination thereof. Types of network 1300 comprise a packet-switched, circuit-switched, connectionless, connection-oriented network, interconnected networks, or any combination thereof. Orientations of network 1300 comprise voice, data, or voice and data communications. Moreover, transmission media of network 1300 comprise wireline, satellite, wireless, or a combination thereof, etc.

Server 1200 is adapted to receive information transmitted from information device 1100 via network 1300. Server 1200 comprises components such as a user interface 1260 and a client program 1240. User interface 1560 and client program 1540 receive information related to forms from information device 1100 for storage on a memory device 1280 and/or communication to information devices such as an information device 1400 and an information device 1500.

Server 1200 is communicatively coupled to a memory device 1280. Memory device 1280 is adapted to provide information to information devices communicatively coupled to network 1300. Memory device 1280 is adapted to store forms and/or data collected from forms in a manner allowing the information to be accessible from information device 1400, information device 1500.

Memory device 1180 and/or memory device 1280 is any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. Memory device 1180 and/or memory device 1280 are adapted to store forms and/or information collected via the use of forms. Formats to store information in memory device 1180 and/or memory device 1280 comprise database standards such as XML, Microsoft SQL, Microsoft Access, MySQL, Oracle, FileMaker, Sybase, and/or DB2, etc.

For the form user, system 1000 comprises information device 1400, which comprises user interface 1460 and/or client program 1440. The form user accesses, views, completes, and/or revises information on forms via user interface 1460. Forms are rendered on user interface 1460 using client program 1140. Forms are obtained from and/or provided to server 1200 and are stored on memory device 1280 via network 1300. Using information device 1400, the form user obtains, reviews, enters, and/or revises information related to forms and/or cells thereof, and/or obtains, reviews, and/or prints uncompleted, partially completed, and/or fully completed forms.

Information device 1500 comprises user interface 1560 and client program 1540. Information device 1500 and the respective components thereof function in an analogous manner to information device 1400 and the components thereof.

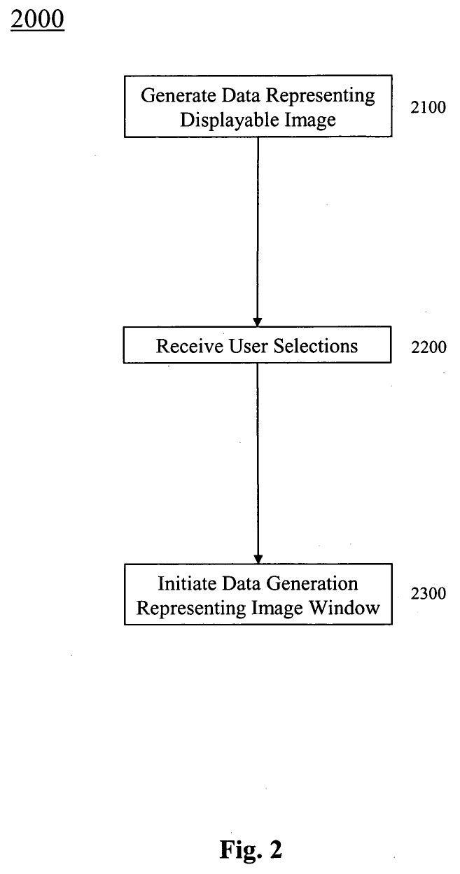

FIG. 2 is a flow diagram of a method of use 2000 for providing a user interface. At activity 2100, data representing a displayable image, such as a control panel, is generated. The forms management system is based upon a single control panel. Other windows supporting form creation and/or modification are activated from the control panel and/or from other windows activated therefrom. The control panel supports building web-based forms for applications such as healthcare applications. The control panel screen comprises workflow icons to access integrated navigation and applicability wizards. The forms management system comprises integrated maintenance functions.

In the forms management system, the term “navigation wizard” corresponds to a user interface that allows the form designer to assign one or more dynamic run-time behaviors (i.e., assign conditions) to a form element after that element is assigned to a form. The navigation wizard allows form elements to work and act differently according to the context in which they are used. For example, in the run-time environment (i.e., what the form user perceives), when the question “diabetic?” is answered, the answer may determine other elements and/or options that are shown to the form user.

A user interface for creating, editing, executing, and/or assigning criteria to a form is referred to herein as an “applicability wizard”, “applicability criteria builder”, and/or “criteria builder”, etc. Via such an interface, characteristics of the form are established by the provision of one or more form definitions. Form definitions comprise conditions, criteria, actions, and/or logical operations associated with using the form, etc.

Features of the forms management system comprise:
combining hardware and/or software components adapted to render forms via visual display (i.e., a “screen building system”) and hardware and/or software adapted to provide printed forms (i.e., a “printed form building system”) into one system (the combination of these two features into one system provides the form designer with an ability to copy a screen form to a printed form, which reduces rework when creating a printed form as output from a screen form);
supporting a “one screen” building workflow with applicability criteria definitions within the form; defining and previewing navigation wizard definitions from one central control panel within the building workflow (this is conducive to normal workflow and/or provide the form designer with one place to review conditional logic within the context of the form definitions; and
providing a basic structure of a generic web form-building system (e.g., XML web pages generated are adapted for use inside and/or outside the healthcare industry).

Once a user interface of an added form has been designed, the added form is renderable from a parent form in a “modal” and/or “modeless” manner. If a form is displayed in a modal manner, the parent program cannot continue running beyond a statement that displays its modal child form unless the running of the modal form is terminated. The modal form communicates the actual reason for termination to its parent form. Any additional information that needs to be communicated to the parent form of the modal form is accomplished by setting elements or properties of the modal form prior to its termination. If a form is displayed in a modeless manner, its running is not controlled by a parent form and/or it has no parent form.

In various embodiments, the forms management system combines a screen and a print form building system into a single system. This provides form users with significant cost savings related to training costs, as well as decreasing time to implement and document system adaptations. From a usability perspective, this enables the form designer to create forms for data collection and copy them to printed versions of the forms.

The forms management system provides additional user interfaces and/or user interface elements comprising an import and/or export utility, which allows form creation in a test environment followed by importation of forms to a production environment. The form designer selects components to be exported. The system creates an XML file, which includes component definitions and form settings. This file is imported to a selected environment.

The forms management system comprises: adaptation functions for forms, such as modifying an elements allowable value selection list, adding graphic images (hospital logos, body images, etc.), defining calculated elements, etc.; functions for extending system class model dictionary entries, which are user defined fields identifying for a specific use, definitions of associated system provided, user defined, elements; and defining “dynamic business logic” for both data collection screens and print forms. Dynamic business logic refers to rules using characteristics such as conditions and/or criteria to change forms and/or form elements that are provided to the form user in a runtime environment. As used herein, the term “runtime environment” refers to what a form user experiences when a form management system operates. Typically in a runtime environment the form management system collects, edits, modifies, and/or renders information related to forms.

The architecture of the form determines what information appears on forms that are rendered and/or printed. For an exemplary form, an architecture determines: what fields display; the tab order; the form specific defaults; allowable values; required fields; conditional logic definitions; presentation attributes associated with the form; a form active and/or a form inactive date; a signing indicator associated with form usage; business units with which the form is associated; keyword associations; model form identifiers; form behavior associations; and/or security task associations; etc.

Forms are used as a data collection method for functions such as orders, manual result entry, assessments, and/or other documentation needs, such as those associated with HIPAA. In addition to determining which information is displayed, the form also defines printed output, which may be the same as a collection form definition, or it may be different. Form-type and/or usage define allowable data entry criteria for a particular form. A triggering module for a specific form defines allowable applicability criteria for a form based on the form type and/or form usage. Allowable applicability criteria are presented to the form designer based on the values that are defined and/or supported by the module. For example, in a healthcare system, forms related to service orders support variables such as health care unit, service, service sub-type, and/or patient type, etc.; while forms related to admission assessment support variables such as health care unit, patient location, patient age, and/or user specialty, etc.

Creating form definitions involves providing rules, or conditions, for behavior for how form elements are displayed, printed, and/or collected, etc. Conditions allow for the grouping of elements and element sets into standard, dynamic formats with specific behavior in the forms management system. Specific behavior comprises: an ability to dynamically add elements or element sets into a form when the form user is filling out a form; special logic and behavior when a predefined answer or value suggests additional documentation be collected; signing capabilities for allowing and/or capturing human signatures and/or proxies thereof; form context requirements (driven by form type); applicability criteria definitions (driven by form type and/or form usage); and/or rules for generating the form for use by the form user (e.g., one version of a form per patient, one version of a form per visit, driven by form type), etc.

In healthcare applications, clinical data collection needs sometimes vary greatly by location (country, state) and/or specialty (acute care, rehab, psychiatric facility, multi-entity vs. single entity, etc.). Governmental agencies and/or specific hospital policies may drive variations in data collection needs. Changes to data collection needs motivate an organization to implement changes. The forms management system supports the form designer's desire to implement changes efficiently.

Numerous user interface controls, elements, and/or tools are accessed via the control panel and/or the forms management system for invoking and/or controlling the display of desired windows. The controls, elements, and/or tools are organized and/or rendered hierarchically, perhaps as nodes in a tree-like hierarchy. User interface controls, elements, and/or tools include:
element navigation wizard: each element has its own navigation wizard that allows a form designer to define what happens when certain values are entered into the element. For example, an element navigation wizard for body temperature receives, from a form designer, a definition and/or commands to display a warning and/or instructional dialog, form element, and/or form if a form user enters a patient body temperature above a predetermined value, e.g., above 104 degrees F.;
trigger definition window: a form element is associated with a trigger that comprises a condition. For example, in a healthcare setting, if a patient has a fever over 104 degrees Fahrenheit the trigger displays a form element requesting a second test. As the form designer changes the trigger definition, the window is updated to show the current definition;
trigger(s) for element name: each element of the form has one or more triggers. Sometimes the form designer wants to view, modify, and/or delete particular triggers associated with an element;
trigger n: each trigger is associated with an element and comprises a definition that determines when a particular trigger is invoked. The form designer expands or collapses a trigger definition window that also updates displayed trigger definitions in sentence format (buttons such as, for example, Add Trigger and Remove Trigger also enables the form designer to insert and/or delete triggers);
condition n: conditions are typically associated with triggers. The form designer specifies associations between conditions and triggers. For example, in a healthcare a trigger is set for patient age exceeding 65. A condition associated with the trigger is that the patient has a high fall risk. An action is to render a fall prevention program message. Controls for setting conditions comprise Add Condition and/or Remove Condition buttons, etc;
trigger name nnn: trigger names identify and distinguish triggers from one another. Trigger parameters are typically accessed, viewed, and/or changed via a user interface comprising characteristics of a particular trigger;
list of elements: a form comprises a plurality of elements, each of which has a distinct name. Elements are alphabetically listed and/or trigger names that are associated with particular elements. User interfaces listing elements are dynamically updatable;
operator: operators are associated with actions comprised in triggers. Operators comprise enable, disable, visible, invisible, mandatory, optional, set focus, and/or display message, etc. For example, a display message operator causes a rendering of a predetermined message via a user interface responsive to a trigger;
operator list: the form designer typically is provided with a list of operators from which to choose for a particular action. For example, for a particular trigger type available operators comprise valued, not valued, equal, not equal, greater than, less than, equal to or greater than, equal to or less than, true, and/or false, etc. Condition and trigger definition windows are typically dynamically updated responsive to operator changes;
value: each particular trigger comprises a value selected or defined value that invokes the particular trigger. Values are constrained by the type of trigger. For example, if the trigger has an editable or non-editable selection list type, a value selected or provided is displayed; if the trigger has a numeric list type, the value entered or provided is displayed, and when the form designer clicks on this node a Trigger Value modal form is displayed, the Trigger Value modal form allows the form designer to enter a number equal to or between ranges allowed for an element; when a new trigger is selected, a default value associated with a trigger definition is provided; for an element with a numeric list, if no numeric default is defined, a low value is provided as the default value; for an element with allowable values, if no allowable value is defined as the default, the first item in an allowable value list is provided as the default value; and/or for an element with a single or multi line text editor, the Trigger Value modal form is displayed and allows the form designer to enter a text value);
value list: trigger value assignments are amenable to providing the form designer with a list from which to choose a value associated with the trigger;
values for findings with ranges: the form designer sometimes selects a value for the trigger within a predetermined range. Sometimes the form designer selects values responsive to a list comprising a range of values.

Valid operators comprise “EQ”, “NE”, “Valued”, and/or “Not Valued”, etc. Critical ranges are evaluated as true at runtime if either a condition “critical indicator” is valued (e.g. “critical low” or “critical high”), or a condition “abnormal indicator” is valued. For example, characterizations of a value provided via the form user comprise: 0.Critical Low; 1.Abnormal Low; 2.Abnormal High; 3.Critical High, 4.Abnormal; and/or 5.Critical; etc. Critical and Abnormal indicators are based on values defined within a service catalog for a given observation. The service catalog comprises an index of indicators related to patients. The service catalog comprises ranges for indicator values and threshold levels above or below which the values are considered low, high, abnormal, and/or critical, etc. Triggers based on a particular critical indicator being valued would be considered “true” if any value within the range of critical or abnormal values for the critical or abnormal indicator was entered. For example; a “critical temperature” is defined as any value over 104 degrees. If the given value for a patient's temperature were valued at 105 degrees, the critical indicator for this observation would be valued as true, displaying the value as 105 degrees.
connector: if more than one condition is defined for a trigger, the form designer establishes a relationship between the conditions. For example, the form designer selects a connector such as AND, OR, and/or a combination thereof, etc.;
connector list: lists available connectors when more than one condition is defined for the trigger;
action n: in setting up a trigger the form designer associates an action with the trigger. Systems comprise control buttons such as Add Action and/or Remove Action);
target member: the form designer accesses a user interface that comprises a same list of elements as a list of elements available in a trigger list. The trigger list is alphabetical and/or associated with element icons;
target message: an action operator indicates that a message is displayed responsive to a form user input satisfying a condition. Typically a user interface renders a Trigger Message modal form wherein the form designer enters a message which is associated with the trigger. A trigger message form allows the form designer to assign a priority to the message such as warning, informational, and/or critical, etc.;
remove trigger: the form designer may decide to remove a trigger altogether. A utility to remove the trigger is rendered via a button and right click menu item. Remaining triggers are renumbered;
remove condition: the form designer may decide to remove a condition. A utility to remove the condition is rendered via a button and right click menu. Remaining conditions are renumbered;
remove action: the form designer may decide to remove an action. A utility to remove the action is rendered via a button and right click menu. Remaining conditions are renumbered;
add trigger: the form designer may elect to add a trigger. The trigger is added via a button and right click menu. Remaining triggers are renumbered;
add condition: the form designer may elect to add a trigger. The condition is added via a button and right click menu. Remaining conditions are renumbered;
add action: the form designer may elect to add an action. The action is added via a button and right click menu. Remaining actions are renumbered;
OK: the form designer typically assents to changes via an affirmative instruction provided via a user interface element such as a button; which saves, for example, a navigation wizard definition with an element on a form that is currently being edited. The affirmative instruction also typically closes an element navigation wizard form. An element navigation wizard definition is not saved until the form is saved;
Cancel: used if the form designer desires to revert to previous form definitions. An affirmative instruction removing changes made via a user interface element is provided using a control element such as a button. For example, the button closes an element navigation wizard form without saving an element navigation wizard definition; and/or
Reset: used if the form designer desires to revert to default form definitions. An affirmative instruction for restoring default form definitions is typically provided via a user interface element such as a button. For example, default values replace a last saved element navigation definition and render the default definition in the element navigation wizard, thus overwriting a current element navigation wizard definition.

Controls used on the form to create forms, edit forms, present data, capture data, and/or to provide navigation comprise: labels, tree control buttons, and/or icons, etc. Controls in the form of buttons are set up for navigational efficiency, such as an OK button, cancel button, help button, and/or reset button, etc. Each respective function is associated with a set of keyboard selections, or “hot keys”.

In developing and/or modifying forms the form designer supplies information, tied to a user interface, which provides documentation regarding the form.

At activity 2200, user selections are received. User selections comprise instructions specifying a form name to be created and/or modified, a suggested structure and/or overall appearance of the form, and/or a default set of information to be collected via the form, etc. The form is created or modified responsive to the user selections.

At activity 2300, a generation of data representing an image window is initiated. The data representing an image window is generated responsive to user activation of at least one selection, such as a button or hyperlink adapted to be selectable by the form designer.

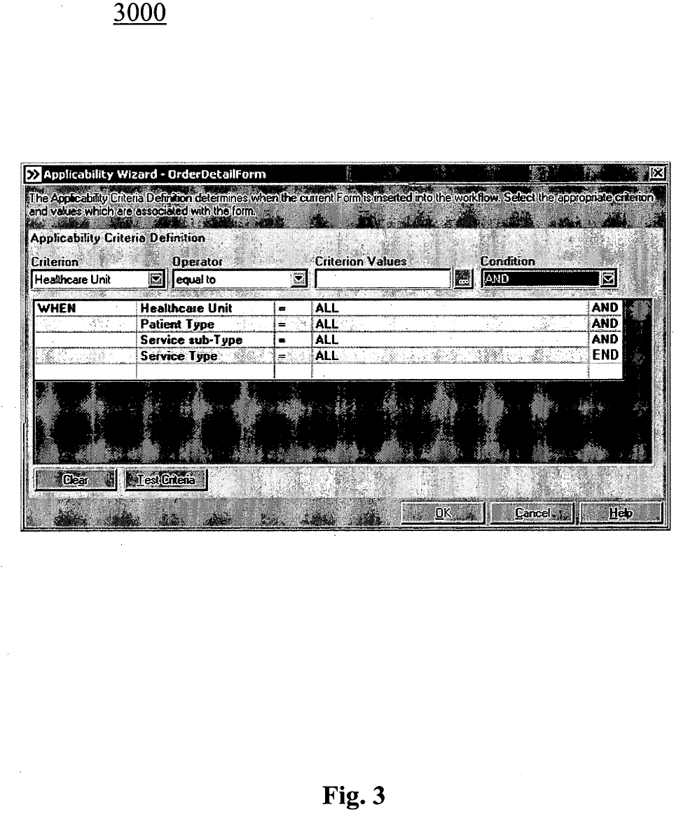

FIG. 3 is a user interface 3000 for an applicability wizard, which provides an option to define and associate criteria to the form. The applicability criteria builder is a tool that serves the purpose of creating, editing, executing, and assigning applicability criteria to a form definition. User interface 3000 is launched from the control panel. User interface 3000 provides options to define and associate criteria to a form. User interface 3000 also provides a mechanism to test the applicability criteria without persisting them (i.e., saving for long term use), thereby allowing the form designer to do a duplicate check. The system supports the ability for the form designer to define and maintain sets of criteria that are used by a system runtime environment to identify the appropriate form to use, and render from an identified form object, based upon contextually relevant information (e.g., data entered by the form user analyzed with respect to criteria) available from the runtime environment.

The applicability criteria wizard is accessible via a user interface called a “form editor”. The wizard is not available until a form type has been assigned to the form, and if there is a corresponding service name to invoke that retrieves an allowable applicability criteria set from a module associated with form usage. Each module that uses an adaptable form implementation publishes a “com”, or executable, component that allows retrieval of applicability criteria.

When available applicability criteria have been made available, a user interface associated with the applicability criteria wizard is rendered for the form designer. The form designer is able to specify appropriate contexts within which a particular form may be invoked in a runtime environment. The form designer enters each criterion as a condition statement, the syntax of which is governed by the editing mechanism of the wizard.

Examples of applicability criteria for a healthcare system by form type and corresponding workflow are shown in Table I.

TABLE I

| Adaptability | | Clinical Desktop |
|---|---|---|
| System Form Type | Applicability Criterion | Workflow |
| Order Detail Form | Entity, Healthcare Unit | Ordering Workflow on a |
| | (HCU), Patient Class, | Clinical System Charting |
| | Service Type, Service | Task Card |
| | Sub Type, and Service | |
| Assessment Page | HCU, Hospital Service, | Assessment Workflow on |
| Type | Nurse Station, Patient | the Clinical System |
| | Class, Patient Age, Age | Charting Task Card |
| | Unit, User Specialty | |
| Assessment | HCU, Hospital Service, | Assessment Workflow on |
| Columnar Type | Nurse Station, Patient | the Clinical System |
| | Class, Patient Age, Age | Charting Task Card |
| | Unit, User Specialty | |
| Patient | HCU/Entity | Patient Registration |
| Registration | | Workflow on the Clinical |
| | | System Visit Task Card |
| Visit Recording | HCU/Entity and Visit | Visit Recording |
| | Type | Workflow on the Clinical |
| | | System Visit Task Card |
| Patient Discharge | HCU/Entity and Visit | Patient Discharge |
| | Type | Workflow on the Clinical |
| | | System Visit Task Card |

For example, in a healthcare application, an HCU identifier is a generally available piece of data. A module indicates that one or more forms of a specific form type (e.g., order detail, assessment, etc.) are created and associated with a set of applicability criteria that includes the HCU identifier. The form designer maps form A to hospital B by establishing a criterion for this form of “HCU=hospital B”. This association causes form A to be displayed in a runtime environment when the form user requests a form of this type within the context of Hospital B.

The workflow proceeds more quickly and efficiently when the system displays the exact fields needed for the information gathering, such as fields related to a patient's known facts (problems, diagnoses, and demographic data). Patient facts comprise history, problems, allergies, diagnoses, orders, signs, symptoms, notes, goals, and/or findings (assessments and results), etc. The form user is not required to collect irrelevant information for patients whose background does not require such information.

Applicability criteria are evaluated based on a weight method. In this approach, the weight of a criterion is based on an order in which criteria are specified and/or specifications for the weight provided by one or more instructions, such as those found in applicability wizards and/or application modules. A summation of criterion weights for a given form determines a form's rank with respect to the total weight of each other form. If more than one form has the same total and/or cumulative weight, the first active form is rendered for the form user.

Based on the above evaluation technique, a strategy is followed to determine what form to select for an entered set of criteria values. An exact match typically takes precedence over a wild card value. Forms with a greater number of exact matches typically take precedence over a lower number of exact matches. For forms with the same number of wild cards, the values are typically weighted in the same order as they are presented to the form user on a user interface.

Therefore, the forms in Table II are listed in the order they are selected based on criterion defined (wherein AC means applicability criteria). In the example of Table II, AC Value3 is an HCU identifier, AC Value2 is a diagnosis identifier, and/or AC Value1 is a medical procedure identifier. Thus, a value of “Exact” for AC Value 3 means that the form applies to a particular HCU and a value of “All” for AC Value3 means that the form applies to HCUs. Thus, a form that corresponds to exact matches for each applicability criteria is weighted higher than a form that is general for each applicability criteria. Forms with higher weights are presented first to a form user. Alternatively, forms with lower weights are presented first to a form user.

TABLE II

| Forms | AC Value3 | AC Value2 | AC Value1 |
|---|---|---|---|
| Form A | Exact | Exact | Exact |
| Form B | Exact | Exact | All |
| Form C | Exact | All | Exact |
| Form D | Exact | All | All |
| Form E | All | Exact | Exact |
| Form F | All | Exact | All |
| Form G | All | All | Exact |
| Form H/Jan.2 | All | All | All |
| Form I/Jan.1 | All | All | All |

The forms in Table III are presented with respective criteria illustrating selection results (wherein AC means applicability criteria).

TABLE III

| | | | | | Form |
|---|---|---|---|---|---|
| Forms | AC Value3 | AC Value2 | AC Value1 | Stage Date | Selected |
| Form A1 vs. A2 | Exact vs. .All | All vs. Exact | All vs. Exact | 1/5 vs. 1/5 | A1 (AC3) |
| Form B1 Vs. B2 | All vs. All | All vs. Exact | All vs. All | 1/5 vs. 1/6 | B2 (AC2) |
| Form C1 vs. C2 | Exact vs. Exact | All vs. All | All vs. All | 1/10 vs. 1/9 | C1 (date) |

The forms management system supports defining and maintaining sets of criteria that are used by a system runtime environment to identify an appropriate form to use based upon contextually relevant information available from the runtime environment. Primarily, this mechanism identifies an appropriate form to display when a request is made to create a new document or to route a document to a print subsystem.

The forms management system saves applicability criteria definitions and evaluates applicability criteria in runtime environments to determine appropriate form definitions to retrieve. A “DLL” or dynamic link library is a block of compiled code that is shared amongst programs or software modules. Each software module creating and/or modifying a form supplies a DLL that returns applicability criteria valid for a specific form type or usage. The DLL exposes one or more public classes (i.e., categories of objects available to a plurality of software modules in the forms management system), each of which supports an application program interface (API). The API is a set of classes used by a particular software module or set of software modules. An exemplary signature of an API is:
Public Function GetApplicCriteria(pObjAppSession As HApplicationSession, ptXMLString As String, ptErrMsg As String) As Long; where
pObjAppSession is an input parameter for the HApplicationSession object;
ptXMLString—output parameter that contains the applicability criteria in XML format; and
ptErrMsg—output parameter that contains error message string if an error occurs.

Certain applicability criteria maintenance functions prevent access to create and/or modify forms. For example when security maintenance is being performed on applicability criteria, the function returns a status indicating an inability to access applicability criteria information and/or that a reference source cannot be located.

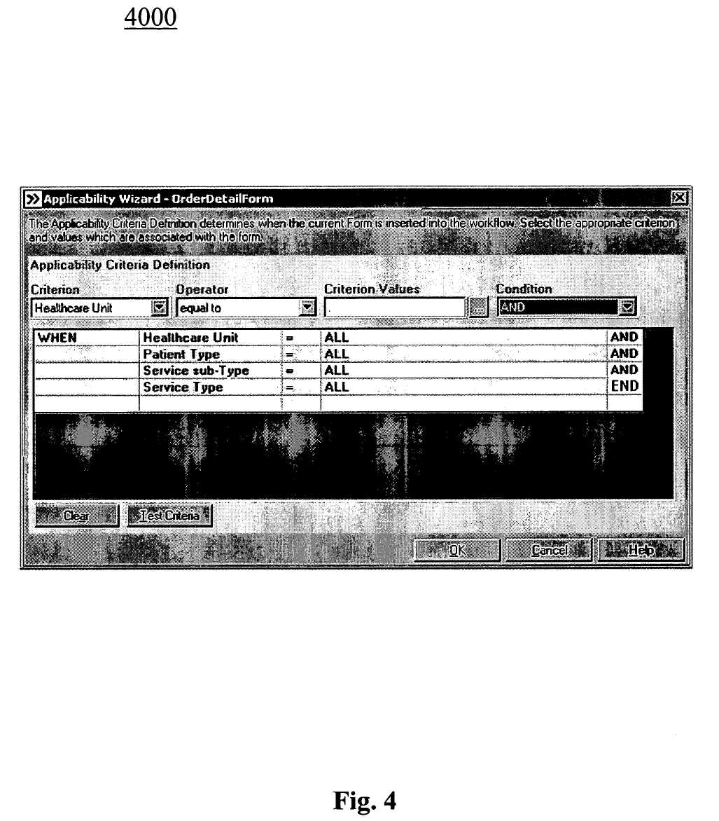

FIG. 4 is a user interface 4000 for defining criteria. When creating or editing applicability criteria the form designer selects a criterion, along with an operator, and value for the criterion, via user interface 4000. An available option provides for testing the given criteria conditions. Hence before persisting the criteria, the form designer test runs the criteria to see whether the given applicability criteria is giving the intended result. The form designer saves the criteria after satisfying that the entered one is the actual one thus preventing the form designer entering redundant or false applicability criteria.

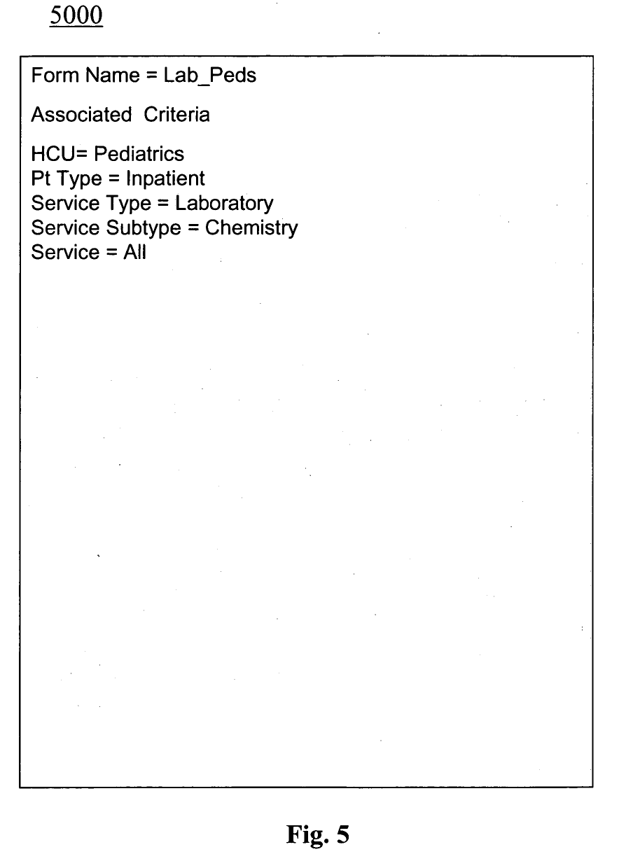

FIG. 5 is a user interface 5000 for viewing criteria, which provides a typical rendering for a pediatrics health care unit. Typical information provided via user interface 5000 for a healthcare application comprises a form name, health care unit, patient type, service type, service sub-type, and/or service, etc.

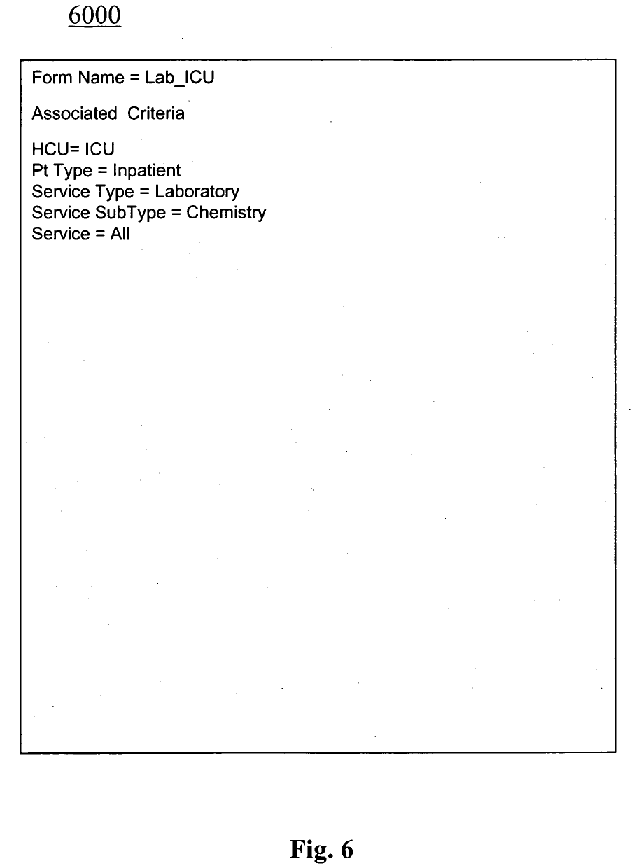

FIG. 6 is a user interface 6000 for viewing criteria, which provides a typical rendering for an intensive care health care unit in a healthcare forms management system.

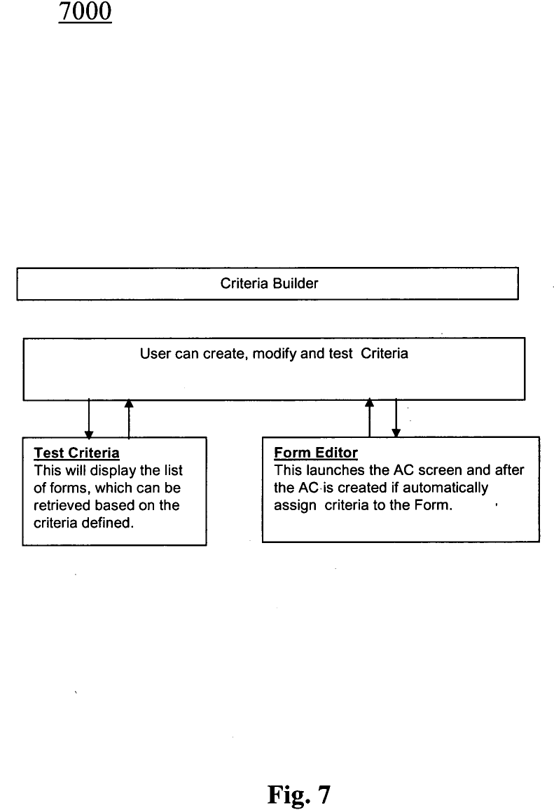

FIG. 7 is a block diagram of a user interaction diagram 7000, which allows the form designer to create, modify, and/or test, etc. criteria without persisting those criteria. When the test criteria button is clicked it displays the forms based on the applicability criteria. The results from using the test criteria are rendered allowing the form designer to verify form performance. When the form is saved from form editor, the applicability criteria defined for the form are automatically saved. Thus, the applicability criteria are linked with the form.

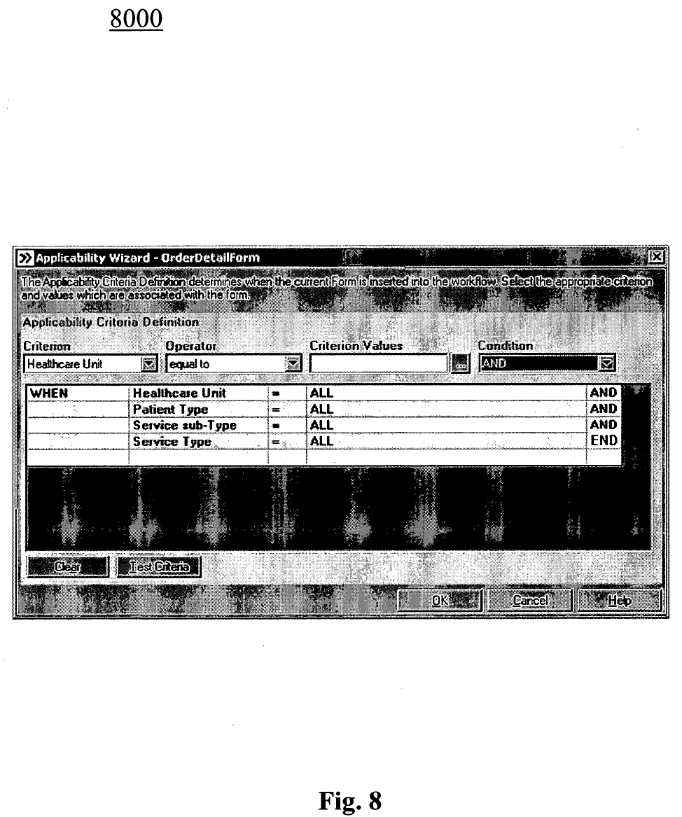

FIG. 8 is a user interface 8000 for associating criteria with a form, which renders a list of criterion such as, for a healthcare application, HCU, patient type, service sub-type, and/or service type, etc. Criteria are obtained based on the form type and form usage from an application module. An initial screen is populated with default values for the criteria. The default value is set to “ALL” i.e., it includes the values. A default operator is EQUAL TO and a default condition is AND.

When the form designer chooses a criterion, the cursor points to a matching name in a grid. The form designer chooses criterion values corresponding to different criteria by clicking on a browse button. A test criteria option is for test running given criteria conditions. Hence, before persisting criteria, the form designer test runs the criteria to see whether a given criterion is giving an intended result. The form designer saves applicability criteria after determining non-redundancy.

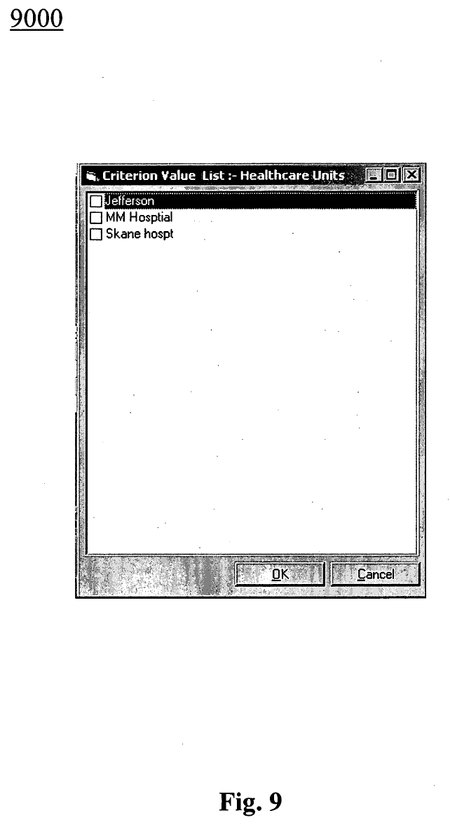

FIG. 9 is a user interface 9000 for listing criterion values. For example, for a particular application, criterion values for a healthcare unit comprise “Jefferson”, MM Hospital, and/or Skane Hospital, etc.

Fields associated with a form comprise:
criterion: allows the form designer to select criterion fields (values for which are decided based on the form type and form usage), wherein application modules pass criteria;
operator: allows the form designer to select the operator related to criterion value selection;
criterion values: allows the form designer to select the criterion values to be given (clicking a button causes a rendering of a value selection window wherein the form designer chooses values for selected criterion, wherein the value list is formulated based on the form type, form usage, and selected criterion);
condition: allows selecting a conditional operator (the last criterion has the condition “END”);
clear: when clicked, clear values of a selected criterion line and makes values associated with that criterion “ALL” by default;
test criteria: when clicked, renders a set of forms based on defined criteria;
OK: saves the criteria chosen and sends the criteria to a document editor;
cancel: closes user interface 9000; and/or
help: when clicked renders a context sensitive help for user interface 9000, etc.

Controls for user interface 9000 comprise VSFlexGrid, command buttons, labels, and/or text boxes, etc. Navigation controls associated with user interface 9000 comprise a clear button, save button, test criteria button and/or key, close button; help button; and/or OK button, etc. Each control is associated with a set of keyboard key selections.

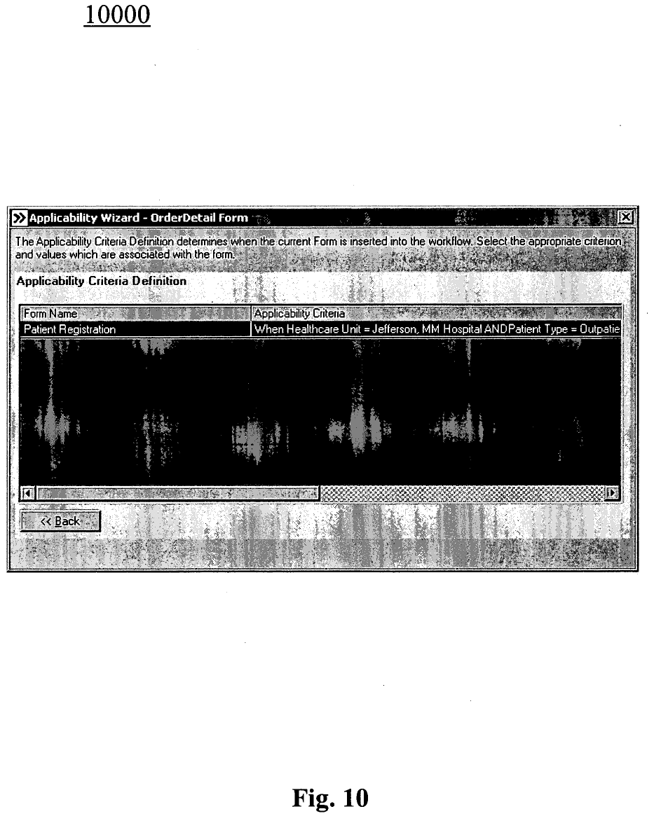

FIG. 10 is a user interface 10000 for inserting a form into a workflow. A criteria form comprises details matching each given criterion. A same user interface rendering is used for viewing an intermediate result while creating and/or editing applicability criteria.

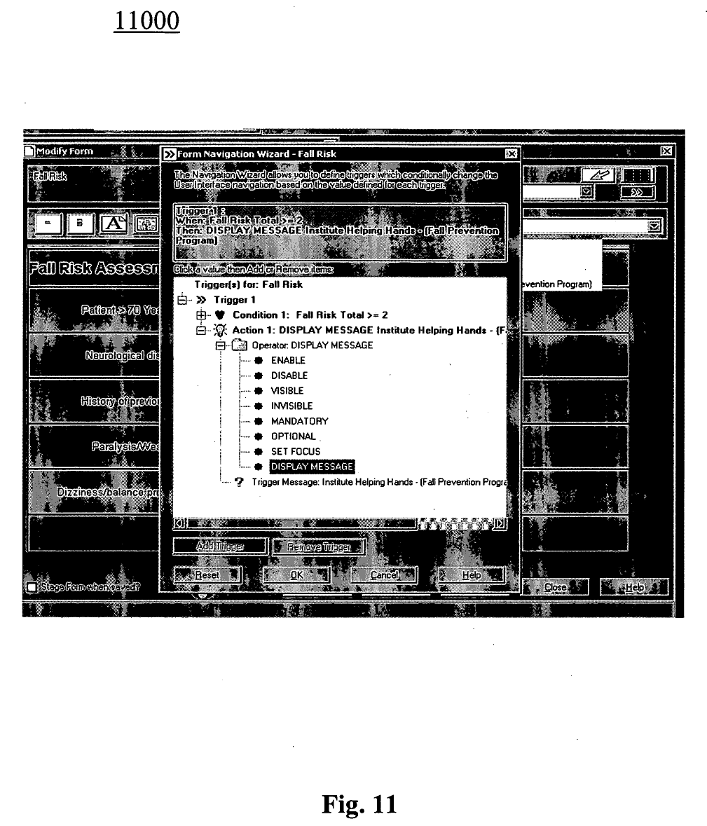

FIG. 11 is a user interface 11000 for a navigation wizard. User interface 11000 allows the form building user to: assign business logic that supports automated form generation and maintenance; construct logic needed to create dynamic behavior; and/or define conditional logic such as, for example, enable, disable, set-focus, make visible, make invisible, display a message, mandatory, and/or optional, etc. Conditional logic is based on values entered by the form designer of the wizard. User interface 11000 supports triggers, conditions, and/or actions.

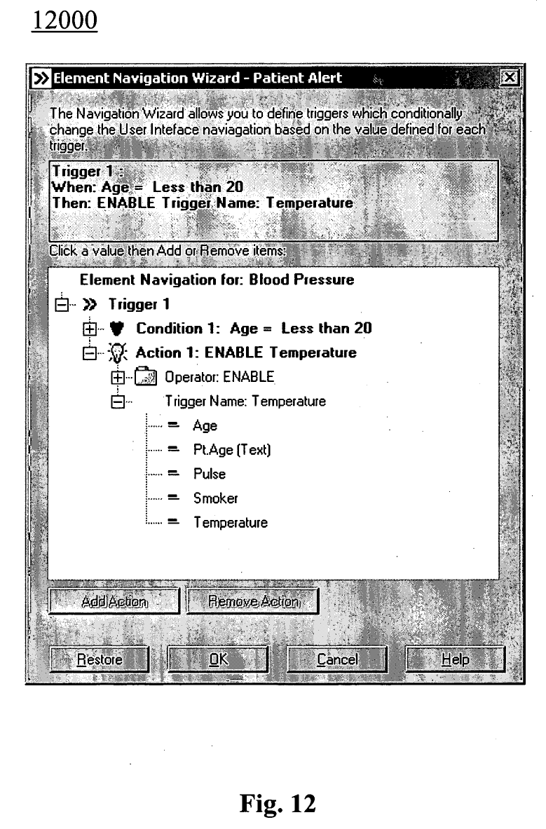

FIG. 12 is a user interface 12000 for applying a trigger, which changes a user interface based on a value of a variable exceeding a predetermined threshold. When building a form the form designer defines triggers for each element on a form in order to perform actions on other elements in the form. These actions comprise making a field visible, invisible, enabled, disabled, required, or optional. Additional actions allow the form designer to determine and/or restrict values in other fields based on a particular conditional trigger and/or to display user-defined messages in a modal message box.

At runtime in order to implement triggers, when the form is loaded, triggers associated with a particular form are evaluated. Based on the existing or default values of fields in the form, trigger action effects on a particular rendering comprise: make visible, make invisible, disable, enable, make required, and/or make optional, etc. When a field associated with a trigger is changed, an appropriate trigger action is checked and invoked if the condition is found to be true.

User interface 12000 allows the form designer to build logic into triggers. Each trigger is made up of one or more conditions and one or more resulting actions. When a form is displayed to the form user at run-time, as each element is valued, the triggers associated with the element are evaluated to determine if any actions should be invoked. User interface 12000 renders one example of a trigger. As items associated with each trigger are selected, the trigger statement is shown in a text area of a window.

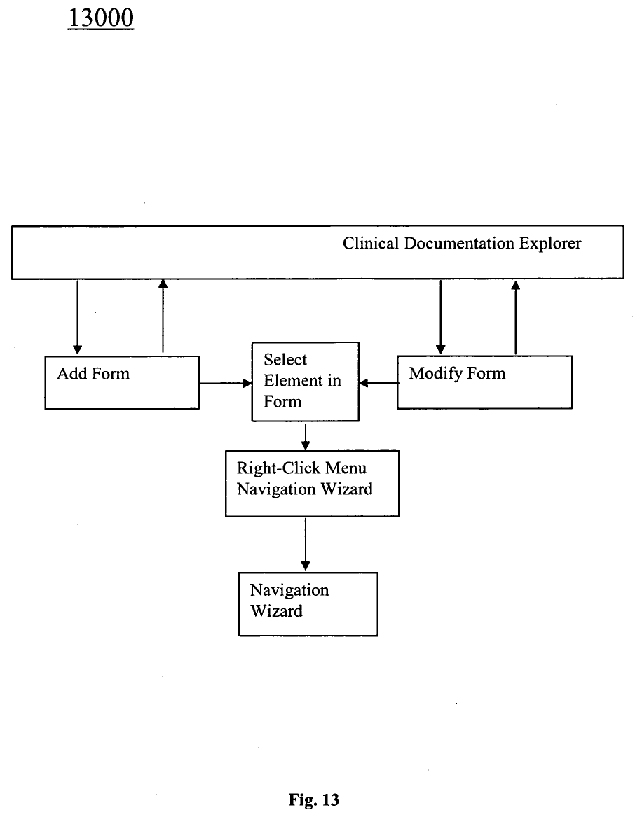

FIG. 13 is a block diagram of a user interaction diagram 13000 for a navigation wizard. The navigation wizard is defined when the form designer is adding or modifying a form. The navigation wizard is associated with the form.

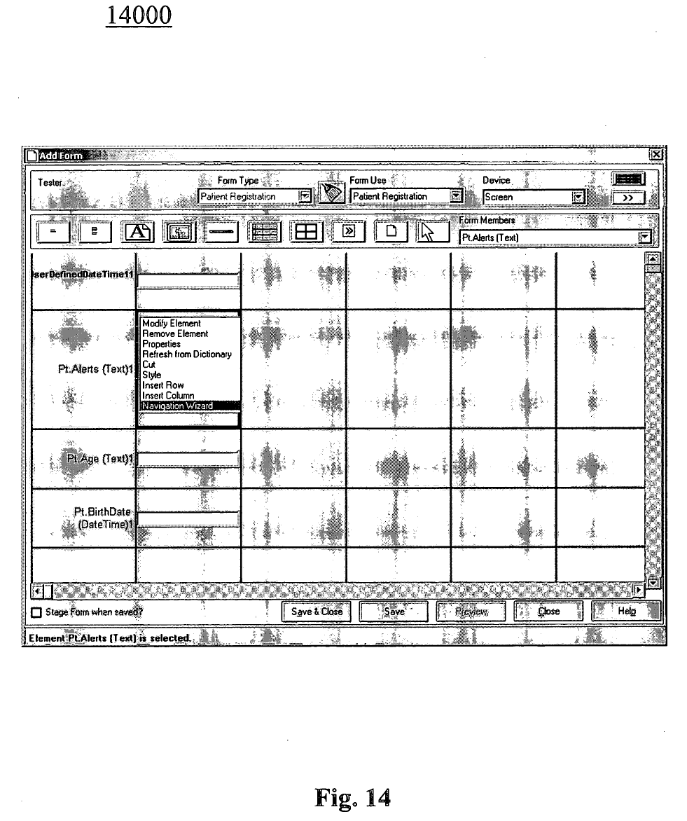

FIG. 14 is a user interface 14000 for selecting a navigation wizard. The form designer invokes the navigation wizard via selecting it from the right-click menu of a selected element of user interface 14000.

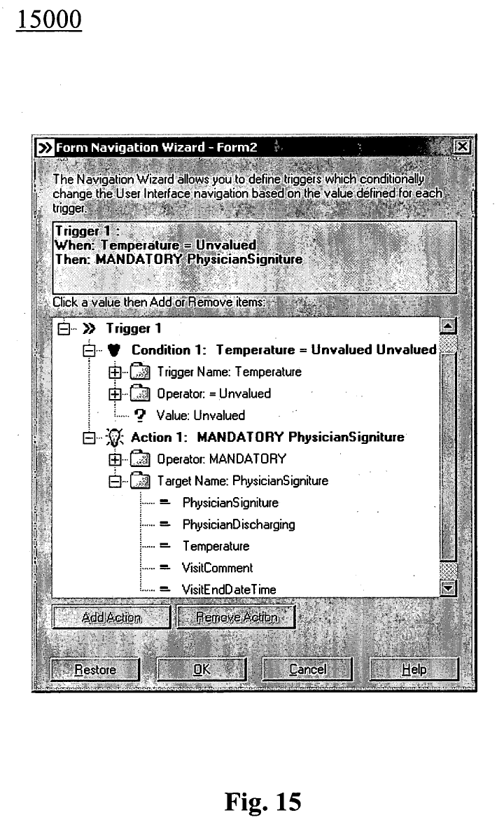

FIG. 15 is a user interface 15000 for a navigation wizard, which allows the form designer to construct run-time logic in which an answer to a triggering element makes other elements visible, invisible, required, optional, enabled, and/or disabled, etc. As used herein “run-time” refers to when the form is rendered and/or used by the form user. As used herein, the term “run-time logic” means conditions related to the form that are established by the form designer and applied when the form is rendered and/or used by the form user. The navigation wizard also allows the form designer to conditionally set focus to another element or to conditionally show user-defined messages.

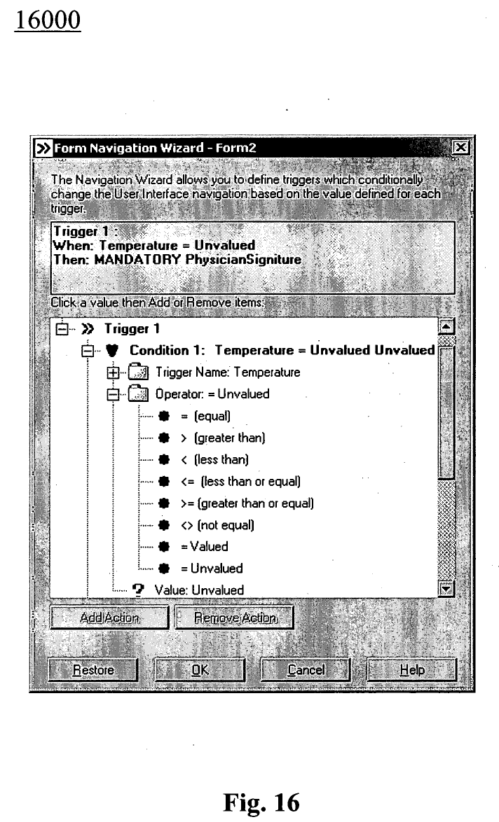

FIG. 16 is a user interface 16000 for a navigation wizard, which allows the form designer to build logic into units called triggers. Each trigger is made up of one or more conditions and one or more resulting actions. When a form is displayed to the form user at run-time, as each element is valued, triggers associated with each element are evaluated to determine if any actions should be invoked.

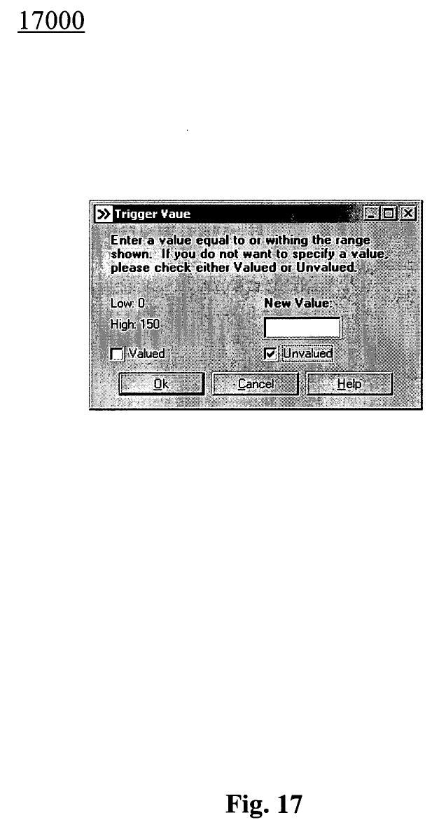

FIG. 17 is a user interface 17000 for selecting a numeric trigger value. A condition defines logic that invokes a trigger. One example of a condition is “Smoker?=Yes”. The condition is made up of a trigger name (Smoker), a trigger operator (=), and a trigger value (Yes). More than one condition is defined for a trigger. The form designer connects them with a connector operator such as AND or OR. Using AND requires surrounding conditions to be true. Using OR requires either surrounding condition to be true.

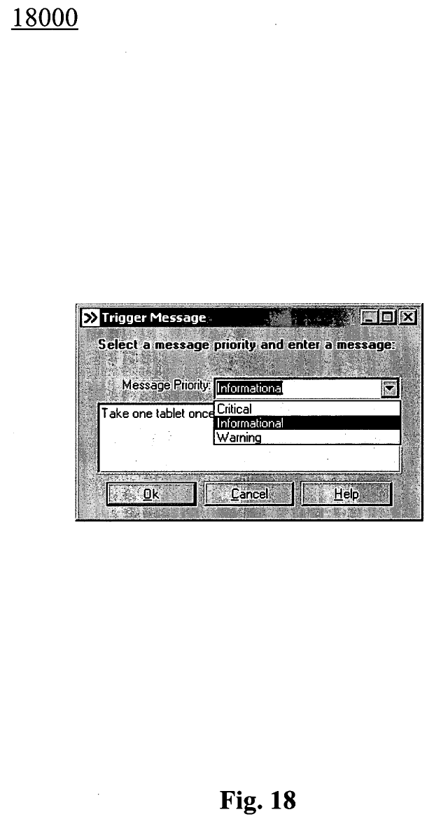

FIG. 18 is a user interface 18000 for selecting a trigger message. Trigger names are elements that are placed on a form and invoke context specific behavior. Trigger names are members of the form but do not have to be visible. Trigger names are elements with an editor type. Editor types comprise numeric, radio button, single line text, multi-line text, editable selection list, non-editable selection list, and/or checkbox, etc.

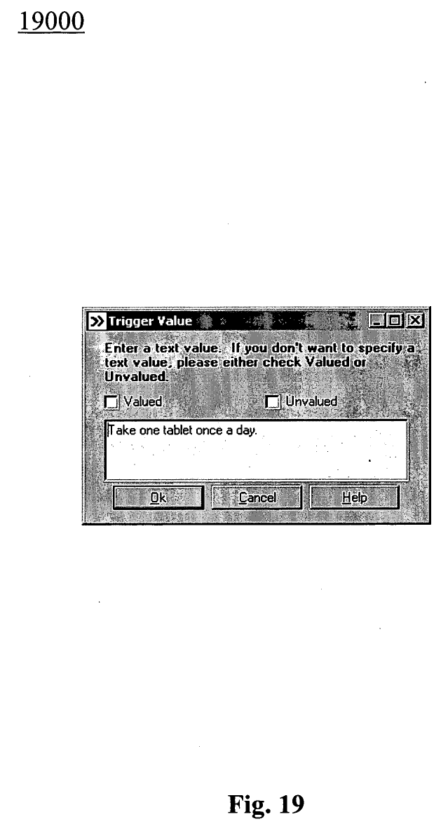

FIG. 19 is a user interface 19000 for selecting a trigger text value.

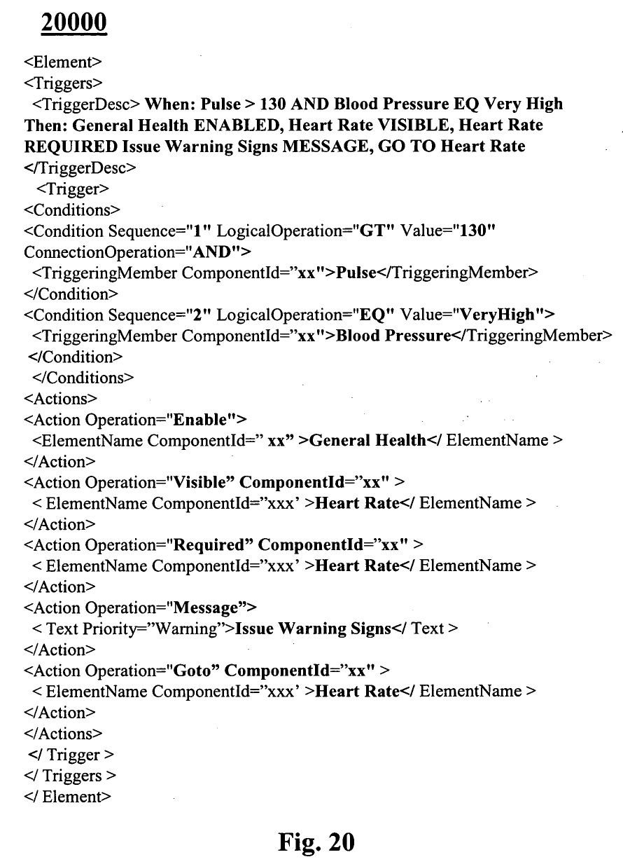

FIG. 20 is a section 20000 of XML code associated with a navigation wizard, which shows attributes associated with a navigation wizard.

The services displayed in Table IV are made available to the system to initialize and populate the navigation wizard user interface and retrieve the information associated with a definition.

TABLE IV

| Service | Parameters | Result |
|---|---|---|
| InitializeNavWiz | PtMembersXML | PtMembersXML as string |
| | as string | Provides the Navigator Wizard |
| | PtOperationXML | with the XML for the Elements |
| | as string | on the Form. It is used to |
| | PtNavWizXML | determine the Trigger |
| | as string | Members and the Target |
| | | Members. |
| | | PtOperationXML |
| | | Provides the Trigger control |
| | | with the list of available |
| | | operators in an xml format. |
| | | Returns a non-zero if there is |
| | | an error. |
| | | PtNavWizXML |
| | | Provide the existing |
| | | Navigation Wizard XML for |
| | | the selected Element. |
| | | <Element> . . . </Element> |
| | | Returns a non-zero if there is |
| | | an error. |
| GetNavWizXML | PtNavWizXML | Returns the <Triggers> xml |
| | as String | associated with the Element |
| | | Navigation Wizard definition |
| | | built by the form designer in |
| | | the control. Returns a non- |
| | | zero if there is an error. This is |
| | | called when the form designer |
| | | clicks OK in the Navigation |
| | | UI. |

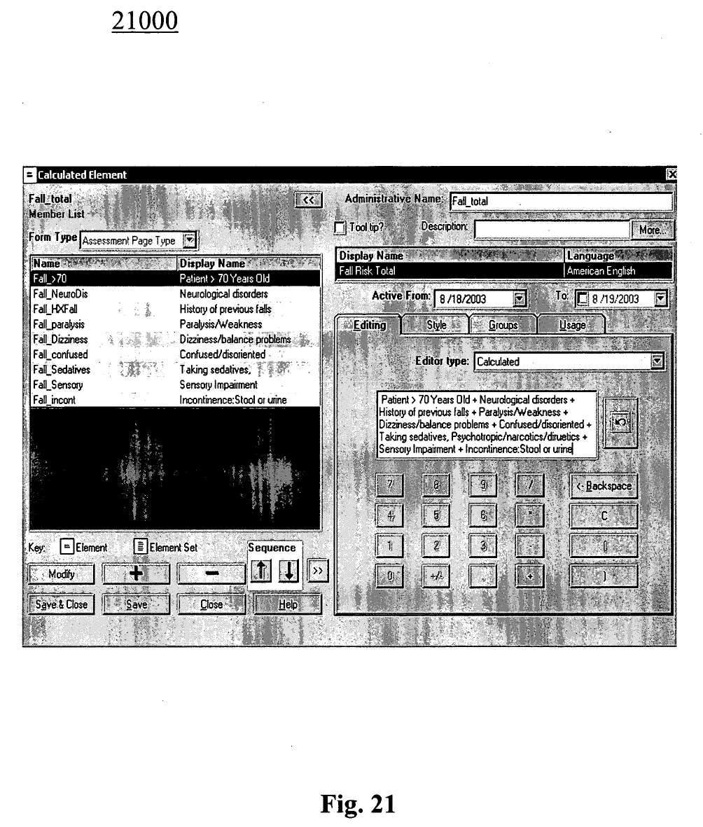

FIG. 21 is a user interface 21000 for a calculation wizard that supports the use of calculations to determine the content and/or logic of a form element.

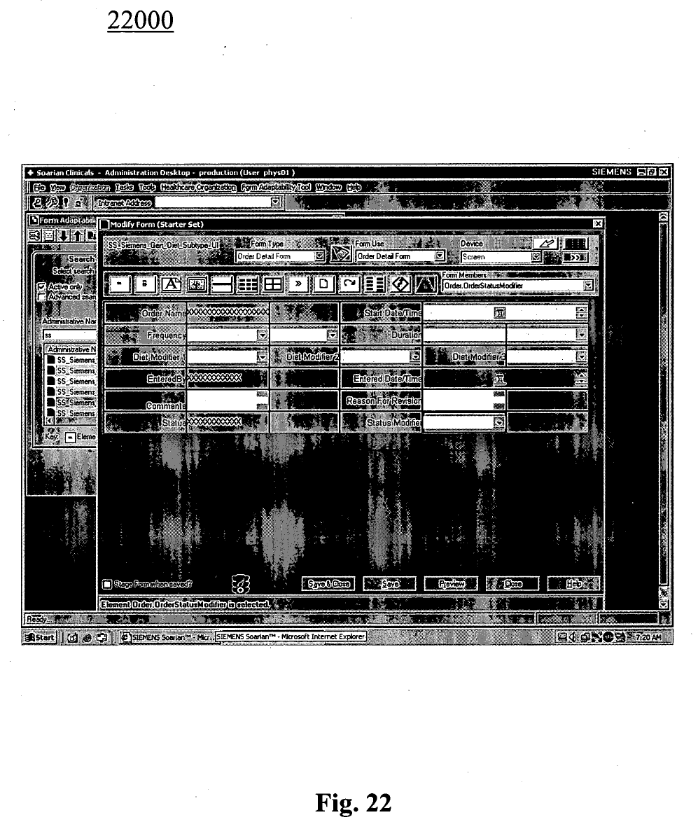

FIG. 22 is a user interface 22000 for modifying a form by a form designer. User interface 22000 allows a form designer, from within a form building workflow, to modify an element, add an element set, set defaults, add keyword groups, and/or add keywords, etc. The forms management system supports navigation within the form building workflow for system maintenance functions.

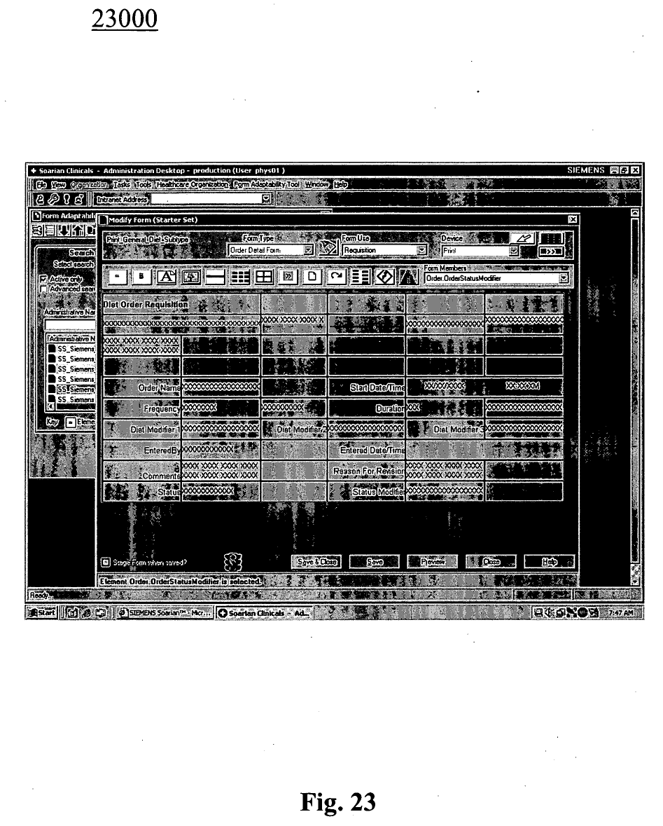

FIG. 23 is a user interface 23000 for modifying a form by a form designer, which enables the form building user to modify how a form prints. The forms management system automatically converts elements from the screen form to the printed form as “read only”. Printed forms support form user defined margin settings and header row definition.

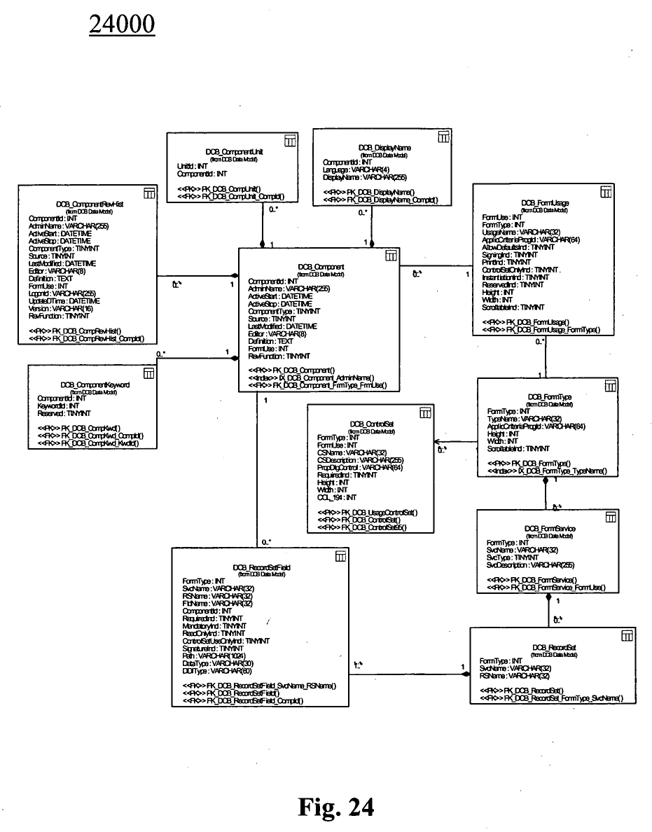

FIG. 24 is a data structure 24000 associated with a form. Data structure 24000 comprises a plurality of tables related to the form. The tables related to the form are named DCB_Component, DCB_ComponentUnit, DCB_DisplayName, DCB_FormUsage, DCB_FormType, DCB_ControlSet, DCB_FormType, DCB_FormService, DCB_RecordSet, DCB_RecordSetField, DCB_ComponentKeyword, and DCB_ComponentRevHist. The form designer sets properties for fields comprised in each table. Using a plurality of linked tables allows the form designer to create adaptive forms for the form user. Information related to the form is stored in a manner adapted to efficient storage, use, and/or retrieval, etc.

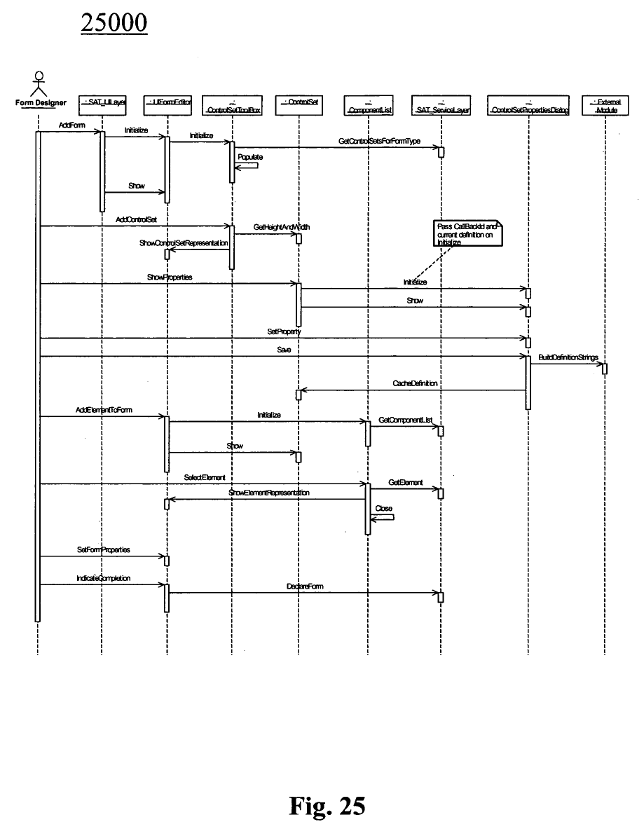

FIG. 25 is a sequence diagram 25000 for creating a form, which illustrates using a plurality of modules comprising a SAT_UILayer, UIFormEditor, ControlSetToolBox, ControlSet, ComponentList, SAT_ServiceLayer, ControlSetPropertiesDialog, and/or External, etc. The form designer provides instructions to add a form, which are received by the SAT_UILayer module.

The SAT_UILayer module initializes the UIFormEditor module, which initializes the ControlSetToolBox module. The ControlSetToolBox module is populated and gets at least one control set for a form type associated with the form from the SAT_ServiceLayer module. The SAT_UILayer module shows a UIFormEditor module rendering of the form to the form designer. The form designer provides instructions to add a control set to the form, which are received by the ControlSetToolBox module. The ControlSetToolBox module gets a height and a width for the form from the ControlSet module. The ControlSetToolBox module shows a control set representation to the form designer via the UIFormEditor module. The form designer provides instructions to show form properties, which are received by the ControlSet module. The ControlSet module initializes the ControlSetPropertiesDialog module, which is shown to the form designer. The form designer provides instructions to set a property related to the form, which are received by the ControlSetPropertiesDialog module. The form designer provides instructions to save properties associated with the form, which are received by the ControlSetPropertiesDialog module. The ControlSetPropertiesDialog module provides the instructions for saving properties associated with the form to the ControlSet module and the External module. The form designer provides instructions to add an element to the form, which are received by the UIFormEditor module. The UIFormEditor module initializes the ComponentList module, which gets the component list from the SAT_ServiceLayer module. The instructions to add an element to the form are shown to the form designer via the ControlSet module. The form designer provides instructions to select an element of the form, which are received by the ComponentList module. The ComponentList module gets the element from the SAT_ServiceLayer module, shows a representation of the element via the UIFormEditor module, and closes. The form designer provides instructions to set form properties, which are received by the UIFormEditor module. The form designer provides instructions to indicate completion of the form, which are received by the UIFormEditor module. The UIFormEditor module provides instructions to declare the form to the SAT_ServiceLayer module.

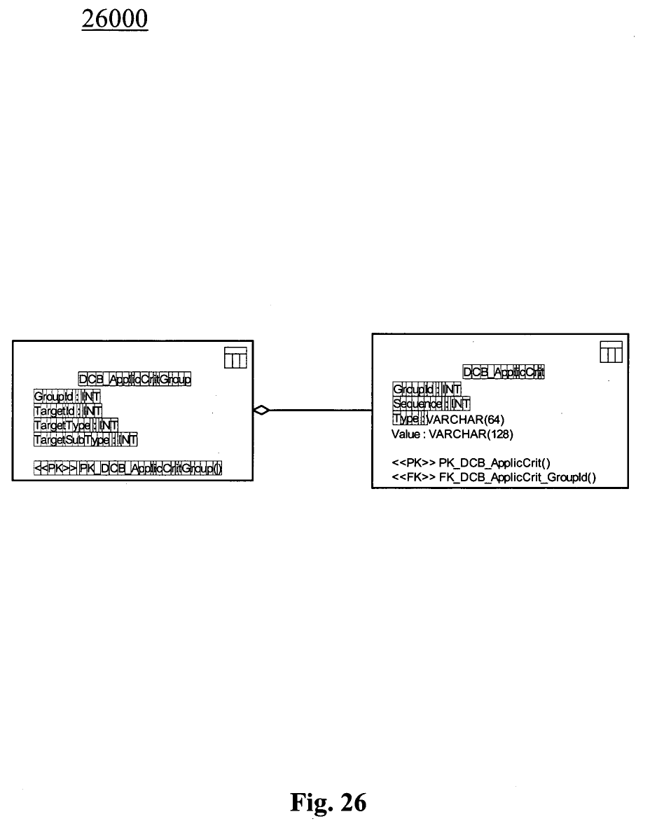

FIG. 26 is a data structure 26000 for applicability criteria. Data structure 26000 illustrates that particular applicability criteria are typically elements of a plurality of applicability criteria. Data structure 26000 comprises definitions for a table DCB_ApplicCritGroup. The table DCB_ApplicCritGroup comprises a group identifier specified as an integer, target identifier specified as an integer, target type specified as an integer, and/or target sub-type specified as an integer, etc. Data structure 27000 comprises definitions for a table DCB_ApplicCrit, which is linked to table DCB_ApplicCritGroup and is a member of a group of applicability criteria. The record DCB_ApplicCrit comprises a group identifier, specified as an integer; sequence, specified as an integer; type, specified as an alphanumeric character string with a maximum length of 64; and/or value, specified as an alphanumeric character string with a maximum length of 128; etc.

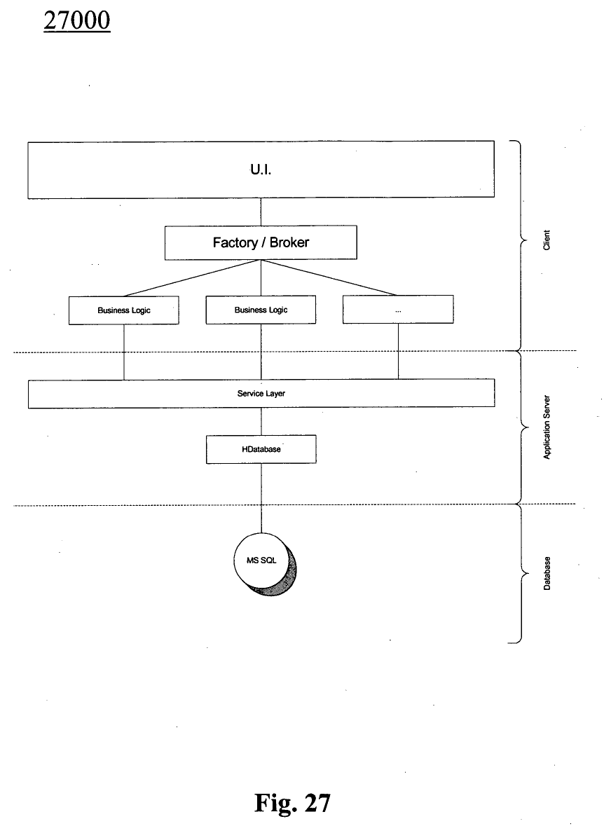

FIG. 27 is a block diagram of an adaptability tool architecture 27000, which comprises two main layers or frameworks. A user interface layer handles interactions with form users and manages business processes. A service layer handles a persistence mechanism for the user interface layer. Business logic is compartmentalized in components within user interfaces. Components are deployed on an application and/or a web server.

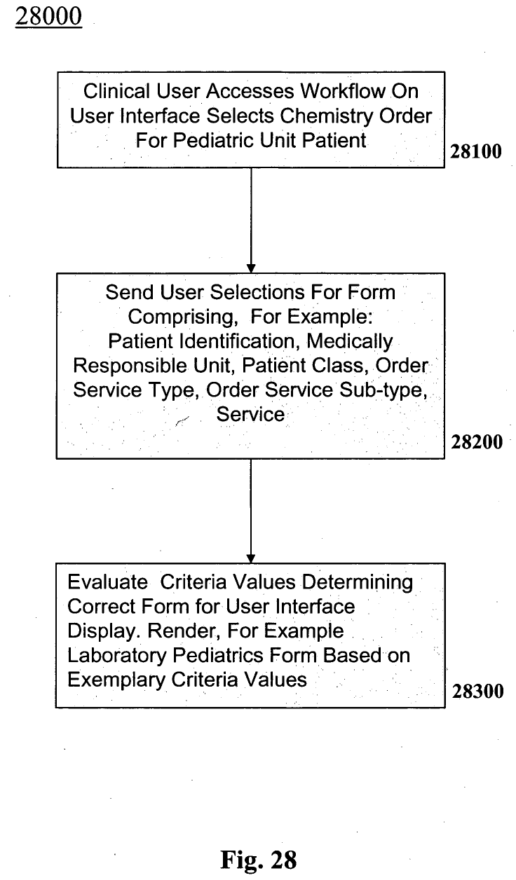

FIG. 28 is a process diagram 28000 for the form user who accesses previously created forms, for the purpose of data entry. At activity 28100 a form user, such as a clinical user, accesses a sequence of forms (a.k.a., a “workflow”) on a user interface. As an example, in a healthcare forms management system, the form user selects a chemistry order for a pediatric unit patient.

At activity 28200, the form user enters data into fields of the form or otherwise activates elements of the form. As an example, typical fields in a healthcare system comprise patient identification, medically responsible unit, patient class, order service type, order service sub-type, and/or service, etc.

At activity 28300, applicability criteria values associated with the form are evaluated to determine the correct next form to display to the form user. For example, in a healthcare application, a first form for gathering information about the patient causes, if the patient is a child, a second form for available pediatric laboratory tests and/or testing procedures to be rendered based on applicability criteria values related to the age of the patient as determined from the first form.

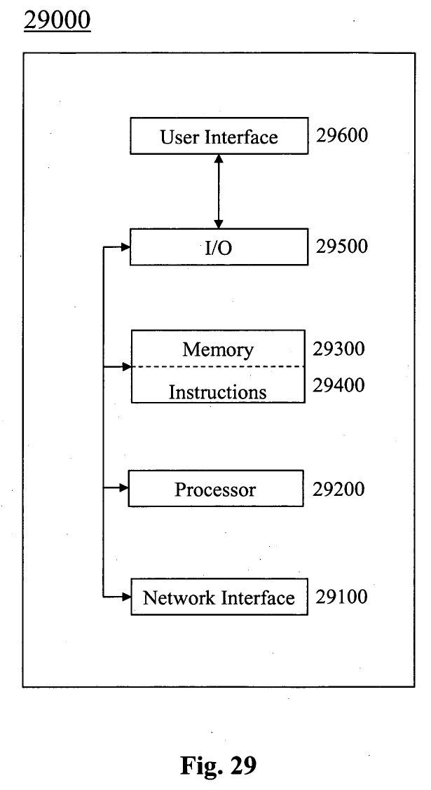

FIG. 29 is a block diagram of an information device 29000, which comprises, for example, information device 1100, server 1200, information device 1400, and/or information device 1500 of FIG. 1. Information device 29000 comprises any of numerous well-known components, such as for example, one or more network interfaces 29100, one or more processors 29200, one or more memories 29300 containing instructions 29400, one or more input/output (I/O) devices 29500, and/or one or more user interfaces 29600 coupled to I/O device 29500, etc. A form designer views a rendering of a form, or windows used in creating or modifying the form, via one or more user interfaces such as, for example, user interface 29600.

Still other embodiments are readily apparent to those skilled in this art from reading the above-recited detailed description and drawings.

1. A user interface system enabling a user to determine properties of an electronic form, comprising:
a user interface image generator for providing data representing a displayable image and for enabling a user to determine properties of an electronic form, said displayable image including:
a first user selectable button enabling user initiation of a first image window supporting user determination of an image element display condition, said condition:
determining when a particular image element is to be displayed in a particular form, and
determining an associated property of said image element; and
a second user selectable button enabling user initiation of a second image window supporting user determination of criteria comprising at least two criterion, the at least two criterion weighted and used in determining when said particular form is to be displayed in response to user activation of a button displayed in an image; and
a user interface command processor for initiating generation of data representing said first image window in response to user activation of said first user selectable button.

2. A user interface system according to claim 1, wherein
said condition is a logic condition, and
said associated property of said image element determines said particular image element is at least one of, (a) visible, (b) invisible, (c) is active and initiates a particular action in response to user selection of said particular image element, (d) is inactive, (e) is optionally selectable by a user and (f) is required to be completed by a user for completion of said form, in response to satisfaction of said condition.

3. A user interface system according to claim 1, wherein
said criteria determines,
(a) selection of said particular form from a plurality of predetermined forms, and
(b) when said particular form is to be displayed in response to user activation of a button displayed in an image of a plurality of sequentially displayed images associated with a corresponding sequence of tasks.

4. A user interface system according to claim 3, wherein
said sequence of tasks comprises tasks managed by a clinical information system, said sequence of tasks being associated with delivering healthcare to a patient.

5. A user interface system according to claim 3, wherein
said sequence of tasks comprises tasks performed by at least one healthcare worker in a workflow employed in delivering healthcare to a patient.

6. A user interface system according to claim 1, wherein
said displayable image includes a user selectable image element enabling user selection of a format for data representing a form suitable for at least one of, (a) printing and (b) display on a reproduction device.

7. A user interface system enabling a user to determine properties of an electronic form, comprising:
a user interface image generator for providing data representing a displayable image enabling a user to determine properties of an electronic form, said displayable image including a user selectable button enabling user initiation of an image window supporting,
user determination of criteria comprising at least two criterion, the at least two criterion weighted and used in determining when said electronic form is to be displayed in response to user activation of a button displayed in an image of a plurality of sequentially displayed images associated with a corresponding sequence of tasks; and
a user interface command processor for initiating generation of data representing said image window in response to user activation of said user selectable button.

8. A user interface system according to claim 7, wherein
said criteria determines when said electronic form is selected from a plurality of predetermined forms.

9. A user interface system according to claim 7, wherein
said sequence of tasks comprises tasks managed by a clinical information system, said sequence of tasks being associated with delivering healthcare to a patient.

10. A user interface system according to claim 7, wherein
said sequence of tasks comprises tasks performed by at least one healthcare worker in a workflow employed in delivering healthcare to a patient.

11. A user interface system enabling a user to determine properties of an electronic form, comprising:
a user interface image generator for providing data representing a composite user interface image enabling a user to determine properties of an electronic form, said displayable image including:
a first image window supporting,
user determination of an image element display condition, said image element display condition determining when a particular image element is to be displayed in a particular form and an associated property of said particular image element;
a second image window supporting,
user determination of criteria comprising at least two criterion, the at least two criterion weighted and used in determining when said particular form is to be displayed in response to user activation of a button displayed in an image of a plurality of sequentially displayed images associated with a corresponding sequence of tasks
and
a user interface command processor for initiating generation of data representing said image window in response to user activation of a user selectable button.

12. A user interface system enabling a user to determine properties of an electronic form, comprising:
a user interface image generator for providing data representing a composite user interface image enabling a user to determine properties of an electronic form and including an image window supporting,
user determination of criteria comprising at least two criterion, the at least two criterion weighted and used in determining when said electronic form is to be displayed in response to user activation of a button displayed in an image of a plurality of sequentially displayed images associated with a corresponding sequence of tasks; and
a user interface command processor for initiating generation of data representing said image window in response to user activation of a user selectable button.

13. A user interface system enabling a user to determine properties of an electronic form, comprising:
a user interface image generator for providing data representing a displayable image enabling a user to determine properties of an electronic form, said displayable image including user selectable buttons enabling user initiation of image windows supporting,
(a) user determination of an image element display condition, said condition determining when a particular image element is to be displayed in a particular form and an associated property of said particular image element and
(b) user determination of criteria comprising at least two criterion, the at least two criterion weighted and used in determining when said particular form is to be displayed in response to user activation of a button displayed in an image of a plurality of sequentially displayed images associated with a corresponding sequence of tasks; and
a user interface command processor for initiating generation of data representing said image windows in response to user activation of at least one of said user selectable buttons.

14. A method for providing a user interface enabling a user to determine properties of an electronic form, comprising the activities of:
generating data representing a displayable image enabling a user to determine properties of an electronic form, said displayable image including:
a first user selectable button enabling user initiation of a first image window supporting,
user determination of an image element display condition, said condition determining when a particular image element is to be displayed in a particular form and an associated property of said particular image element;
a second user selectable button enabling user initiation of a second image window supporting,
user determination of criteria comprising at least two criterion, the at least two criterion weighted and used in determining when said electronic form is to be displayed in response to user activation of a button; and
initiating generation of data representing said first image window in response to user activation of said first user selectable button.

15. A method for providing a user interface enabling a user to determine properties of an electronic form, comprising the activities of:
generating data representing a displayable image enabling a user to determine properties of an electronic form, said displayable image including a user selectable button enabling user initiation of an image window supporting,
user determination of criteria comprising at least two criterion, the at least two criterion weighted and used in determining when said electronic form is to be displayed in response to user activation of a button displayed in an image of a plurality of sequentially displayed images associated with a corresponding sequence of tasks; and
initiating generation of data representing said image window in response to user activation of said selectable button.

16. A user interface system enabling a user to determine properties of an electronic form, comprising:
a user interface image generator for providing data representing a displayable image and for enabling a user to determine properties of an electronic form, said displayable image including:
a user selectable button enabling user initiation of an image window supporting user determination of an image element display condition, wherein said image element display condition is a logic condition, said image element display condition:
determining when a particular image element is to be displayed in a particular form, and
determining an associated property of said image element, wherein said associated property of said image element determines said particular image element is at least one of, (a) visible, (b) is active and initiates a particular action in response to user selection of said particular image element, (c) is optionally selectable by a user and (d) is required to be completed by a user for completion of said form, in response to satisfaction of said image element display condition; and
a user interface command processor for initiating generation of data representing said image window in response to user activation of said selectable button.
